(19) United States
(12) Patent Application Publication
(10) Pub. No.: US 2011/0012400 A1
(43) Pub. Date: Jan. 20, 2011

(54) VEHICLE SEAT WITH A STOWABLE HEAD RESTRAINT AND AN ANTI-WHIPLASH SYSTEM

(76) Inventors: Mike Golin, Dexter, MI (US); Håkan Waldysson, Mullsjo (SE); Markus Olsson, Gothenburg (SE); Rune Karlberg, Bottnaryd (SE)

Correspondence Address: HOWARD & HOWARD ATTORNEYS PLLC, 450 West Fourth Street, Royal Oak, MI, 48067, US

(21) Appl. No.: 12/675,742

(22) PCT Filed: Aug. 29, 2007
(86) PCT No.: PCT/IB07/02554

§ 371 Date: Sep. 1, 2010

(51) Int. Cl. B60N 2/427

(52) U.S. Cl. 297/216.12

(57) ABSTRACT

The present invention relates to a vehicle seat, in particular a backseat, comprising a head restraint (1) mounted on the backrest of the vehicle seat, wherein the head restraint (1) comprises a mechanism for folding the head restraint between at least one fixed operative position and at least one stowage position, characterised in that the vehicle seat further comprises an anti-whiplash system including a release mechanism associated with the head restraint (1), which release mechanism is adapted to, when the head restraint (1) is in an operative position, reduce the gap between an occupants head and the head restraint (1) in case of an accident.

The present invention relates to a vehicle seat, in particular a backseat, comprising a head restraint mounted on the backrest of the vehicle seat, wherein the head restraint comprises a mechanism for folding the head restraint between at least one fixed operative position and at least one stowage position.

The mechanism for folding the head restraint from an operative position to a storage position allows to fold down the head restraint so that the folded head restraint uses more efficiently the available space in the vehicle.

It is important for the safety in vehicles to reduce the Neck-Injury-Criterion level in case of a rear-end impact accident. Rear-end collisions are rarely fatal, but they give rise to fully one quarter of all personal injuries, often with permanent impairment, and to extended sick-leave and inability to work. In addition to the human suffering, these injuries account in many countries for more than 50% of all insurance claims and costs for societies for personal injuries sustained by car occupants.

These whiplash injuries have been linked to a too large gap between the head restraint of the vehicle seat and an occupant's head. In case of a rear-end collision the occupant's body is accelerated forward whereas the head of the occupant accelerates in the gap backwards relative to the vehicle by virtue of its inertia. Thus, the closer the gap is the less the head is dangerously accelerated backwards relative to the vehicle.

A further requirement for head restraints in backseats is that the head restraints of a backseat should be able to move into an inoperable stowage position to increase the available loading capacity of the vehicle and/or to improve the driver's sight rearwards. Such head restraints that can be pivoted into an inoperable position are known from U.S. Pat. No. 6,375,264 B1 or US 2005/0179301 A1.

Head restraint systems reducing the gap between the head restraint of the vehicle seat and an occupant's head in case of an accident are for example known from WO 2005/087536 a1, U.S. Pat. No. 6,830,278 B2 or EP 1 526 982 B1. Such head restraint systems are denoted as active head restraints.

Vehicle seats known from the prior art have the disadvantage that they either provide a head restraint with an anti-whiplash system or a mechanism to stow away the head restraint, not both. It is a further disadvantage of the known mechanisms for stowing away the head restraint that the head restraint is highly integrated into the backrest such that the assembly or the replacement of a head restraint is very difficult.

It is therefore the object of the present invention to provide more safety in a vehicle seat with a head restraint that can be stowed away. Additionally, the head restraint should be easy to assemble and easily replaceable in the event of service or repair.

This object is achieved according to the present invention by the features of claim 1. Preferred embodiments of the invention are subject of the dependent claims.

According to the present invention a vehicle seat, in particular a backseat, is provided comprising a head restraint mounted on the backrest of the vehicle seat, wherein the head restraint comprises a mechanism for folding the head restraint between at least one fixed operative position and at least one stowage position, characterised in that the vehicle seat further comprises an anti-whiplash system including a release mechanism associated with the head restraint, which release mechanism is adapted to, when the head restraint is in an operative position, reduce the gap between an occupant's head and the head restraint in case of an accident.

In a first embodiment of the invention the vehicle seat comprises a preassembled head restraint mounting unit that is mounted in the backrest of the vehicle seat and wherein said preassembled head restraint mounting unit comprises both the mechanism for folding the head restraint and the anti-whiplash system.

The preassembled head restraint mounting unit may be mounted in the backrest of the vehicle seat, preferably at the top of the backrest. The head restraint body may be mounted to the preassembled head restraint mounting unit by two carrier bars. The stowage mechanism can be arranged to pivot the carrier bars forward or backward and thereby pivoting the head restraint to an inoperable stowage position, preferable at an angle approximately 90° in relation to the operative position. The anti-whiplash system may be arranged to ‘lift’ and pivot the movable part of the preassembled head restraint mounting unit forward.

Both the stowage and the anti-whiplash system may be preloaded by springs biasing the head restraint to a folded/crash position respectively. The stowage mechanism can be held in a operative position by a locking mechanism, the latter holding the spring in position. The locking mechanism may be arranged to be intentionally released, e.g. by a button or remote control Preferably, the whiplash protection mechanism is held in an operative position by a locking mechanism, holding the spring in position, the locking mechanism being released in the event of a crash. The locking mechanism may be released by an actuator, the actuator can be pyrotechnic, electromagnetic, mechanical (e.g. occupant body impact actuated), pneumatic etc. The actuator is influenced by a crash sensor, i.e. the locking mechanism is released when a crash has occurred.

In a second embodiment of the invention both the mechanism for folding the head restraint and the anti-whiplash system are placed in the head restraint of the vehicle seat.

The head restraint is very easily replaceable. The stowage mechanism may include a button for intentional release of a locking mechanism to fold the head restraint in relation to the carrier bars, the latter being preferably axially displaceably, but not pivotably attached to the backrest. The anti-whiplash system is also arranged within the head restraint, wherein the anti-whiplash system is able to move the head-engaging member of the head restraint of the body forward to close the gap between the occupants head and the head-engaging member in the event of a crash. Preferably, the anti-whiplash system is released by an actuator under influence of a crash sensor.

In a third embodiment of the invention the vehicle seat comprises a preassembled head restraint mounting unit that is mounted in the backrest of the vehicle seat and wherein said preassembled head restraint mounting unit comprises the mechanism for folding the head restraint, whereas the anti-whiplash system is placed in the head restraint of the vehicle seat.

Some vehicles are equipped with pre-crash warning systems, able to predict an upcoming crash. In such vehicles the anti-whiplash system may be released before the crash has actually occurred, i.e. a pre-crash release. A pre-crash release is applicable on any preferred embodiment.

Preferably in any embodiment of the invention, the release mechanism comprises a movable part and a stationary part, wherein a clearance between the movable part and the stationary part opens up when the release mechanism is released, the release mechanism further comprises a wedging body having a small width portion and a large width portion and an intermediate increasing width portion, wherein the wedging body points with its small width portion towards the clearance between the movable part and the stationary part, and in that the wedging body is movable and preloaded to move into the clearance as it opens up to thereby abut against the movable part and against the stationary part in order to prevent the movable part of the head restraint from moving back.

The term “stationary part” as used herein refers to one or more parts of the head restraint which do not move, when the head restraint is in a fixed operative position and thus do not move during a release action of the whiplash system. Nevertheless, the “stationary part” of the head restraint or parts of it may be movable when the head restraint is not in a fixed operative position. The folding action of the head restraint comprises moving from at least one stowage to at least one fixed operative position of the head restraint, and vice versa. In an operative position of the head restraint the stationary part is immovable with respect to the backseat.

Preferably, the movable wedging body is preloaded by a spring. More preferably, the movable wedging body is urged to gradually rotate into the clearance when the release mechanism is released in order to prevent the movable part of the head restraint from moving back. Thereby, the wedging body gradually fills the clearance as it opens up between the movable part and the stationary part of the release mechanism and abuts against the movable part and against the stationary part.

Preferably, the movable wedging body is an essentially wedge-shaped body. The essentially wedge-shaped body may comprise a sloped surface creating an increased thickness of the body from the small width portion via the intermediate increasing width portion to the large width portion. The wedge-shaped body may be oriented with its apex or small width portion towards the clearance and may slide into the clearance as it opens up.

More preferably, the wedging body is rotatable and comprises a helically shaped surface portion winding up from the small width portion via the intermediate increasing width portion to the large width portion. The wedging body may essentially have the shape of a disc segment that is rotatable about its central axis. The disc segment may comprise one surface having essentially the shape of a circle segment that winds up from the small width portion via the intermediate increasing width portion to the large width portion following a helix. Alternatively, the wedging body may have the shape of a segment of a ring, the ring having an annular surface winding up from the small width portion via the intermediate increasing width portion to the large width portion.

In the first preferred embodiment of the invention the release mechanism is arranged to pivot the head restraint forward with respect to the backrest of the vehicle seat such that an angular-shaped clearance between the movable part and the stationary part opens up near the pivot axis when the release mechanism is deployed and the movable wedging body is urged to move into the angular-shaped clearance.

Furthermore, the head restraint may be connected rotatably about a folding axis parallel to the pivot axis with the stationary part for folding of the head restraint to a stowage position. The folding action in this embodiment includes a forward rotation of the head restraint about a folding axis. This is advantageous as the distance between a backseat and a frontseat is often too small to allow for folding a backrest with a head restraint in an operative position down to a flat position in order to increase the loading capacity in the back of the vehicle. In such a case the head restraint in an operative position hits on the backrest of the frontseat during a folding action of the backrest of the backseat. When the head restraint is folded forward into a stowage position, it is then possible to fold the backseat to a flat position without hitting the backrest of the frontseat and to allow for the head restraint to cache in the footwell of the backseat when the backrest is folded forward.

In the second preferred embodiment of the invention the movable part comprises a head engaging member and at least one rotatable cam attached to the head engaging member. The rotatable cam is also rotatably attached to the stationary part, such that the gap between the head engaging member and the stationary part is increased upon rotation of the cam. The cam comprises an extension such that the extension follows a circular path away from the stationary part when the cam rotates, such that the clearance opens up between the extension of the cam and the stationary part. The movable wedging body is preloaded to move into the clearance as it opens up to thereby abut against the extension of the cam and against the stationary part in order to prevent the movable part of the head restraint from moving back.

In addition, the stationary part may be connected rotatably about a folding axis with the carrier bars for folding of the head restraint to a stowage position. This has the same advantages as already outlined for the first embodiment of the invention.

In the third preferred embodiment of the invention the stationary part of the head restraint of the vehicle seat is connected rotatably about a folding axis with the backrest of the vehicle seat for folding of the head restraint to a stowage position. This embodiment exhibits features of the first and the second above-mentioned embodiments. A head-engaging member is connected to the stationary part which is mounted rotatably about a folding axis on a preassembled head restraint mounting unit. The preassembled head restraint mounting unit itself is mounted in backrest of the vehicle seat. The head-engaging member is connected to rotatable cams such that the gap between an occupant's head and the head-engaging member is reduced upon a concerted rotation of the cams about a transversal axis (transversal is meant herein to describe a direction across the vehicle, perpendicular to the longitudinal axis of the vehicle and parallel to the plane of driving of the vehicle, whereas the longitudinal axis is also parallel to the driving plane and coinciding with the direction of (straight) driving). The head-engaging member and the cams establish the movable part of the anti-whiplash system.

Preferably, in any embodiment of the invention the release mechanism may comprise a returning mechanism for returning the head restraint into its initial position after the release mechanism has been released, wherein the returning mechanism comprises means for returning the movable wedging body back into its initial preloaded position. The returning mechanism can for example be deployed by pressing a button or turning a rotary handle.

It should be understood that apart from the embodiments described herein other configurations of the inventive anti-whiplash system are possible.

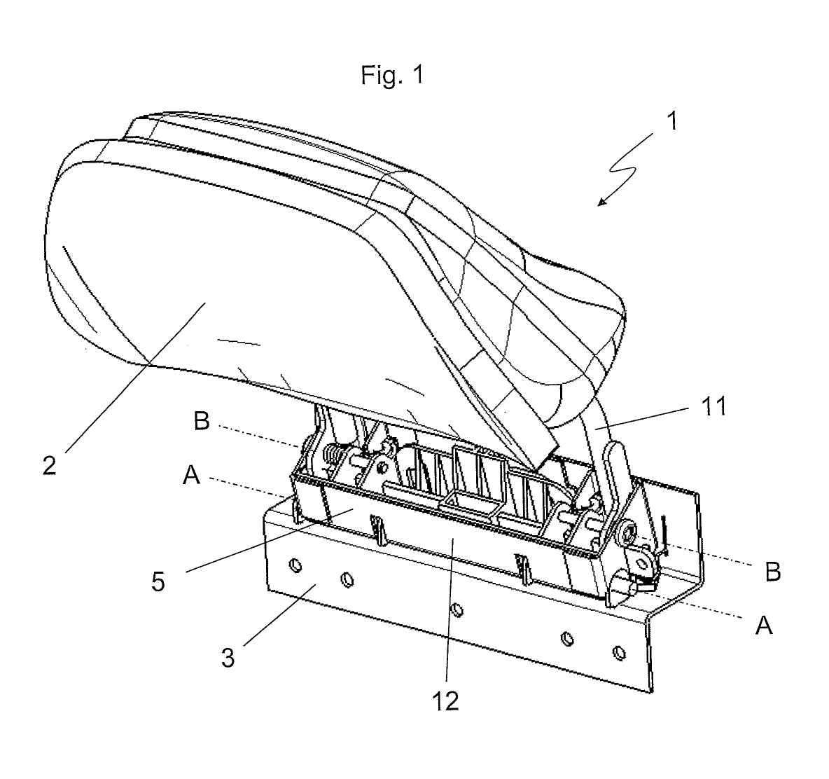

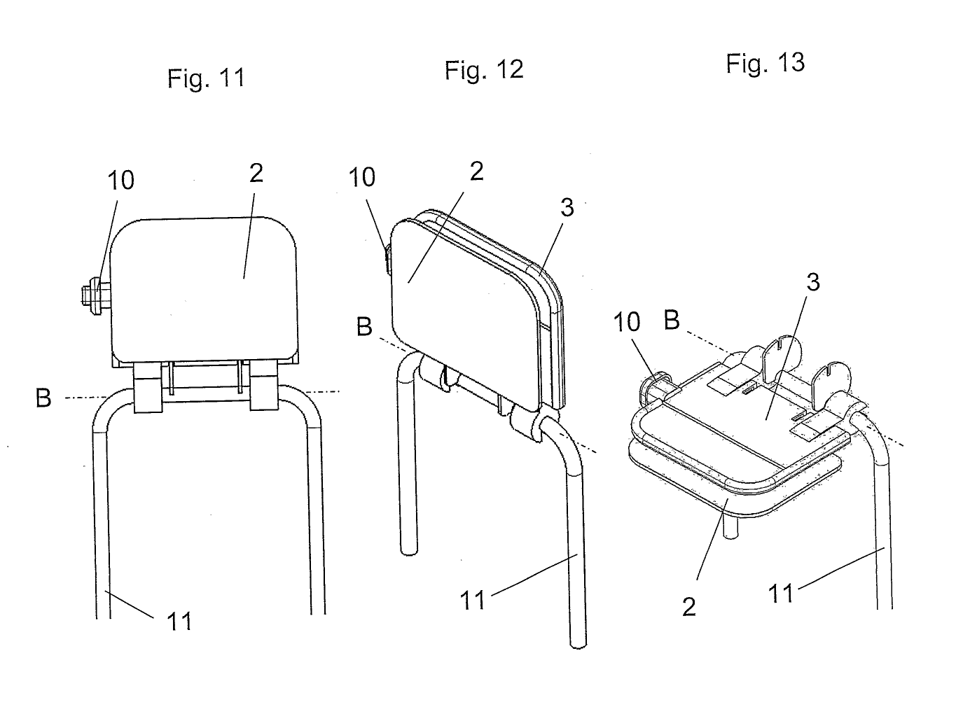

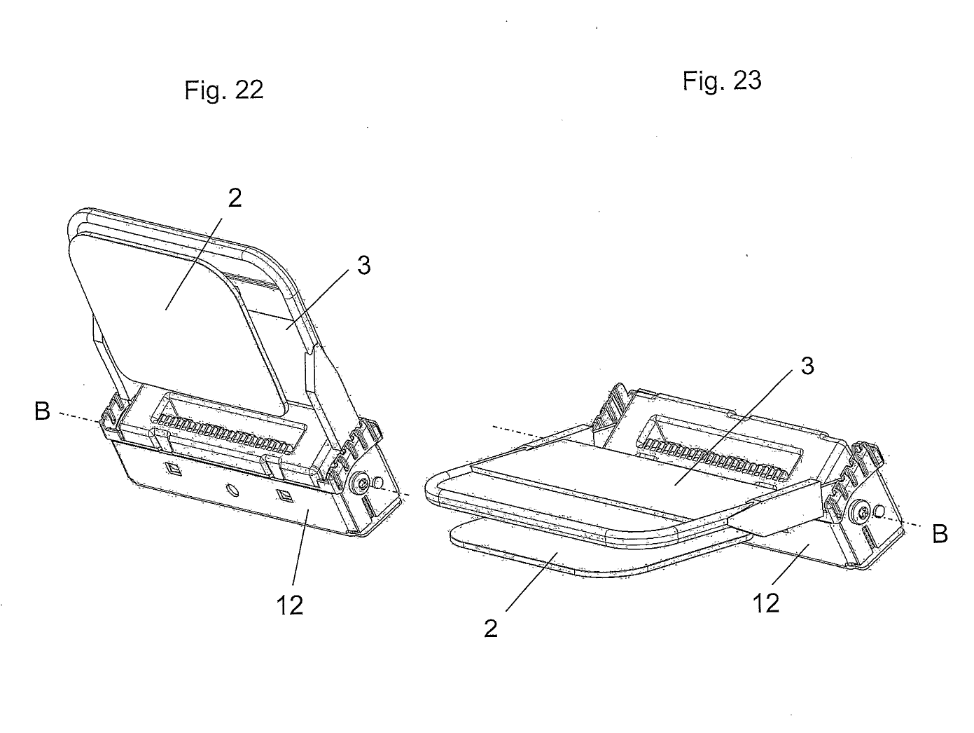

In the following, preferred embodiments of the invention are described in detail with references to the accompanying FIGS. 1 to 23, where the FIGS. 1 to 10 refer to a first embodiment of the invention, the FIGS. 11 to 21 refer to a second embodiment of the invention and the FIGS. 22 and 23 refer to a third embodiment of the invention.

FIG. 1 shows a perspective view of a stowable head restraint in an operative position provided with an anti-whiplash system in an activated state.

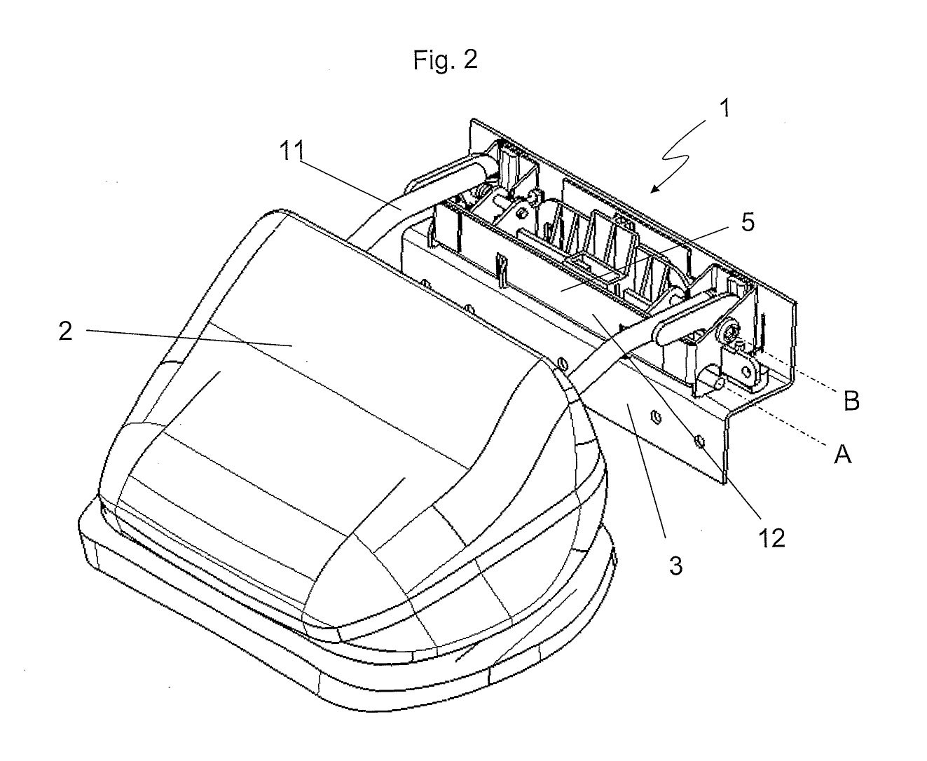

FIG. 2 shows a perspective view of a stowable head restraint stowed away in an inoperable position provided with an anti-whiplash system in an initial state.

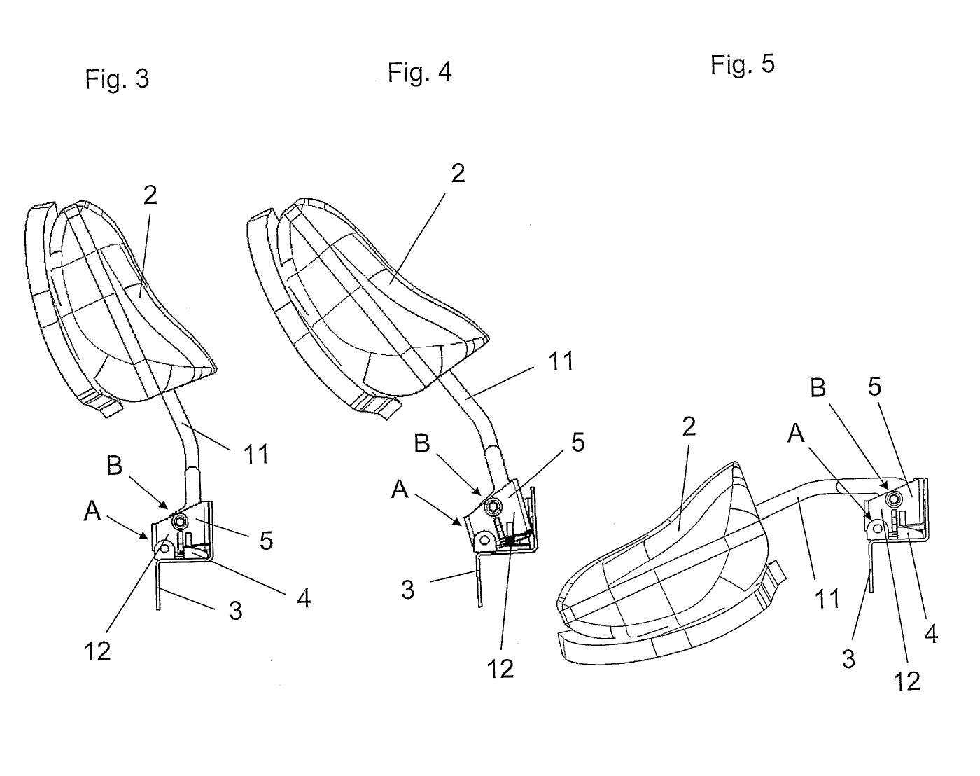

FIG. 3 shows a side view of a stowable head restraint in an operative position provided with an anti-whiplash system in an initial state.

FIG. 4 shows a side view of a stowable head restraint in an operative position provided with an anti-whiplash system in an activated state.

FIG. 5 shows a side view of a stowable head restraint stowed away in an inoperable position provided with an anti-whiplash system in an initial state.

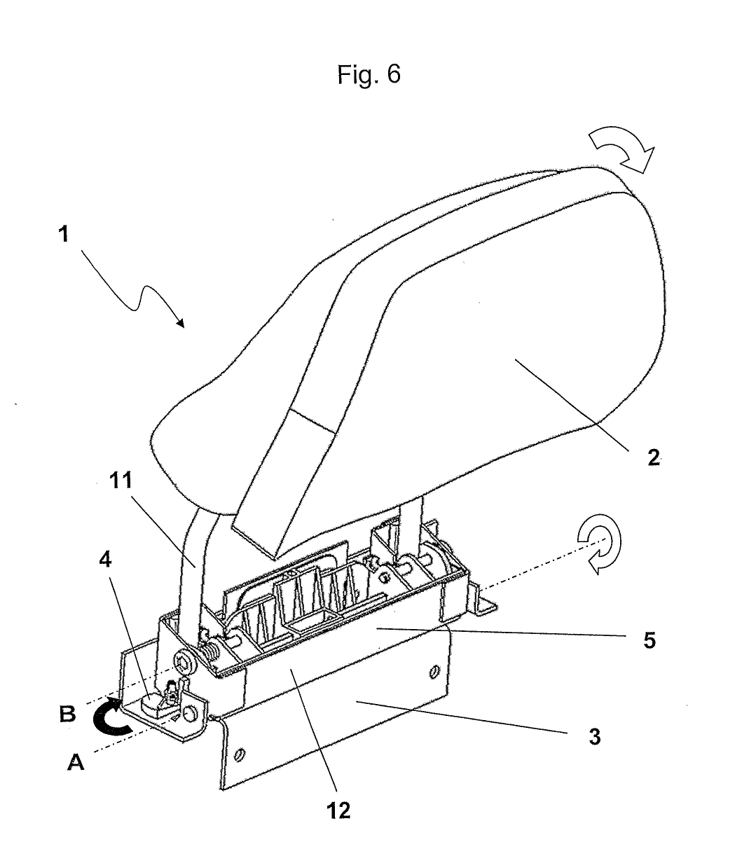

FIG. 6 shows a perspective view of a stowable head restraint in an operative position provided with an anti-whiplash system in an initial state.

FIG. 7 shows a detailed perspective view of the anti-whiplash system in an initial state.

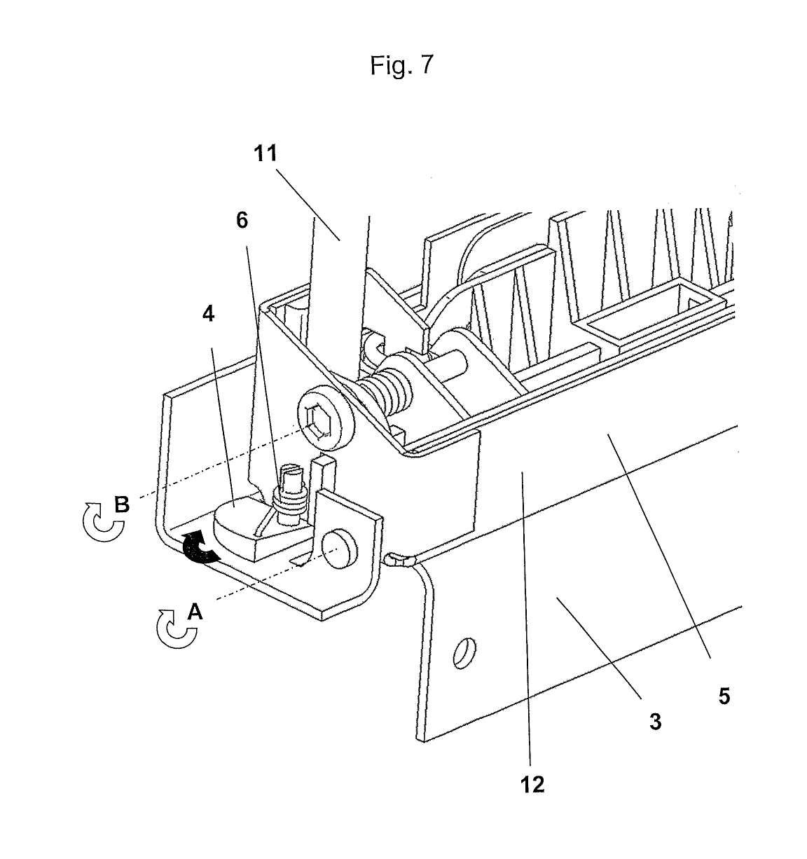

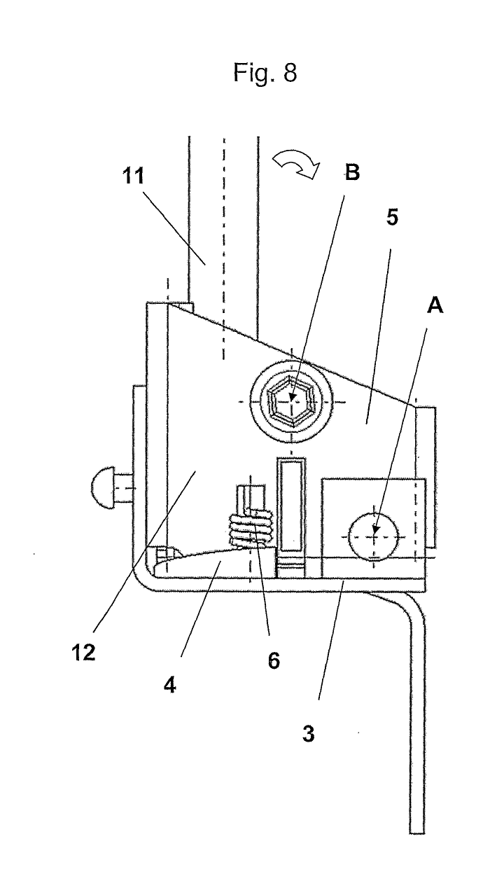

FIG. 8 shows a detailed side view of the anti-whiplash system in an initial state.

FIG. 9 shows a detailed perspective view of the anti-whiplash system in an activated state.

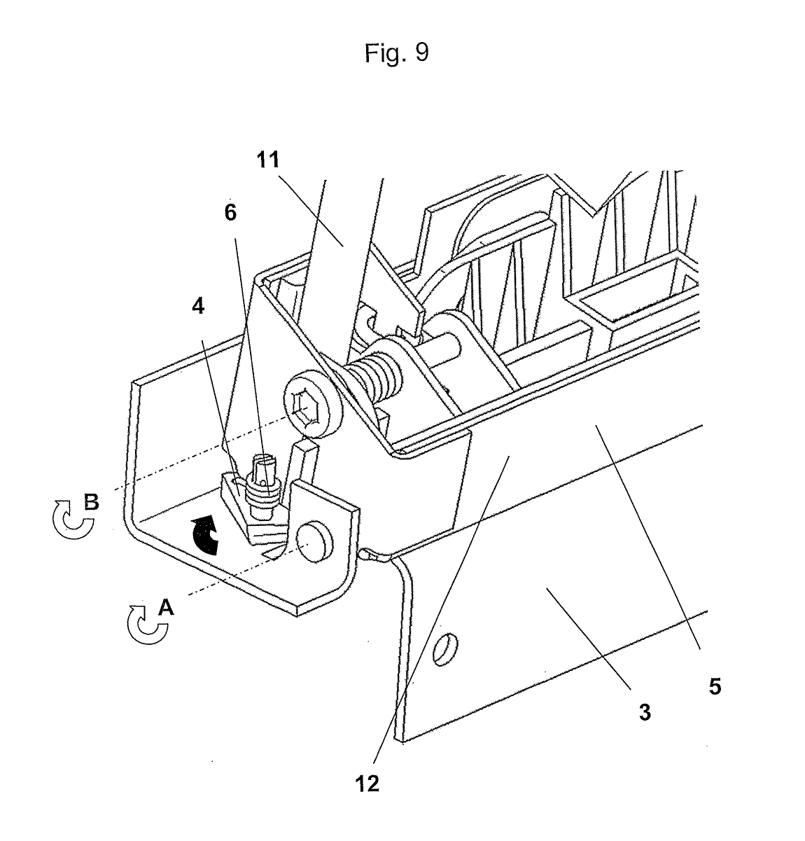

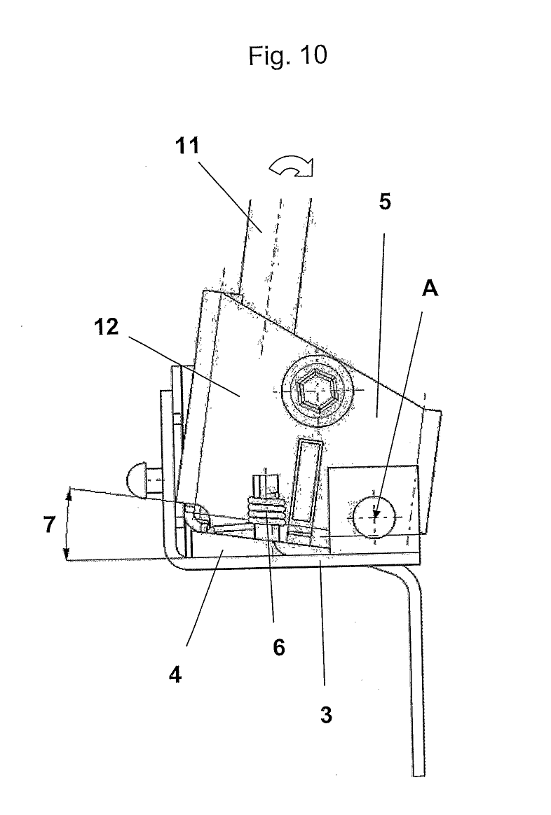

FIG. 10 shows a detailed side view of the anti-whiplash system in an activated state.

FIG. 11 shows a front view of a stowable head restraint in an operative position provided with an anti-whiplash system in an initial state.

FIG. 12 shows a perspective view of a stowable head restraint in an operative position provided with an anti-whiplash system in an initial state.

FIG. 13 shows a perspective view of a stowable head restraint stowed away in an inoperable position provided with an anti-whiplash system in an initial state.

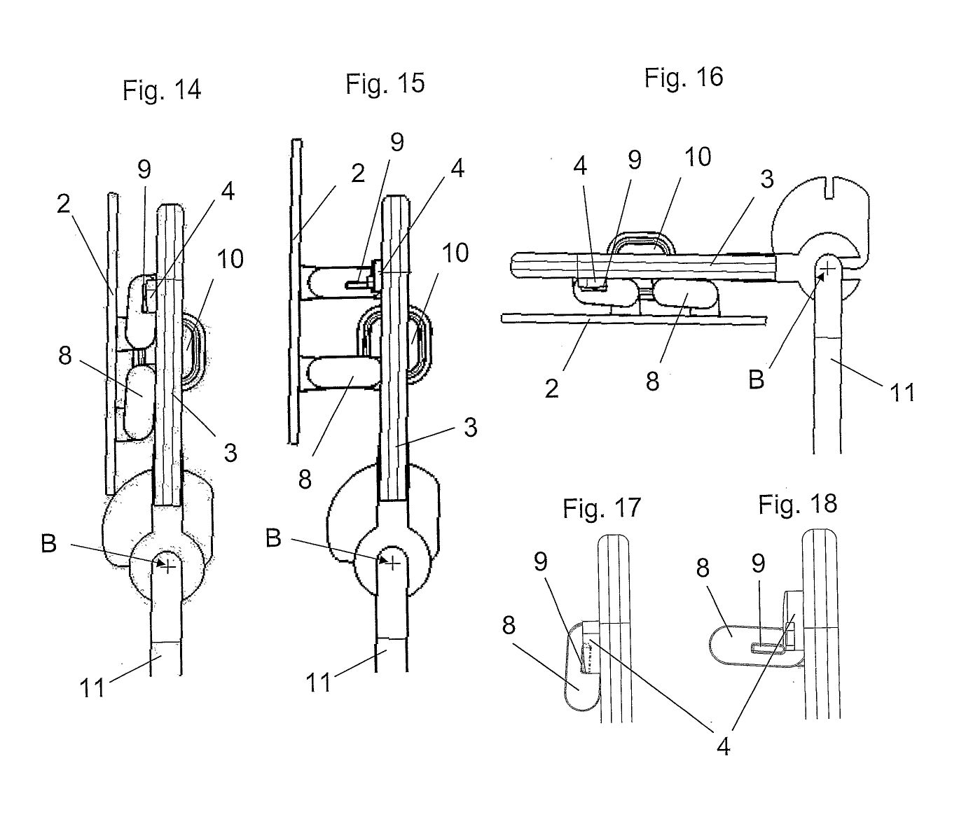

FIG. 14 shows a side view of a stowable head restraint in an operative position provided with an anti-whiplash system in an initial state.

FIG. 15 shows a side view of a stowable head restraint in an operative position provided with an anti-whiplash system in an activated state.

FIG. 16 shows a side view of a stowable head restraint stowed away in an inoperable position provided with an anti-whiplash system in an initial state.

FIG. 17 shows a detailed side view of a stowable head restraint provided with an anti-whiplash system in an initial state.

FIG. 18 shows a detailed side view of a stowable head restraint provided with an anti-whiplash system in an activated state.

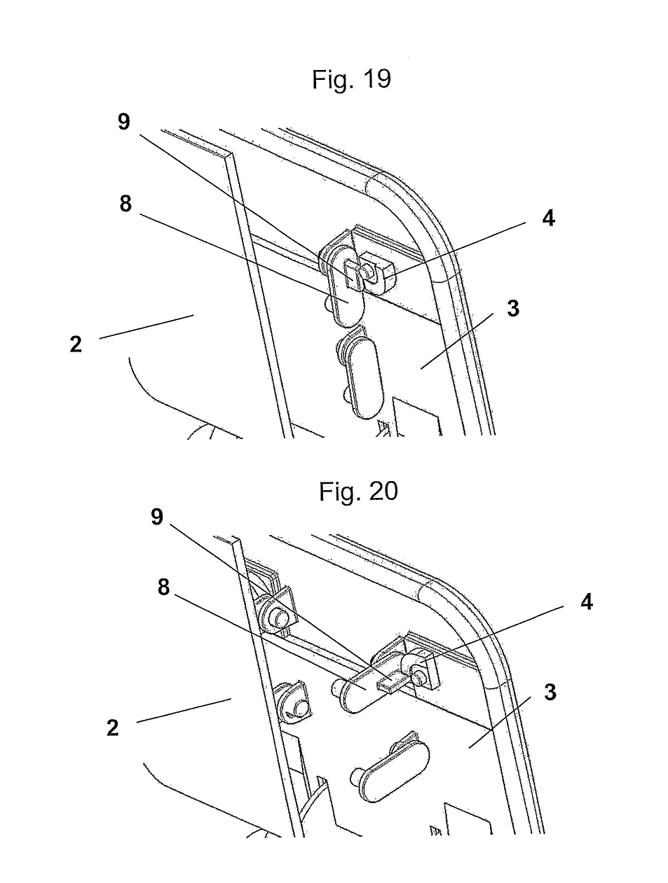

FIG. 19 shows a detailed perspective view of the anti-whiplash system in an initial state.

FIG. 20 shows a detailed perspective view of the anti-whiplash system in an activated state.

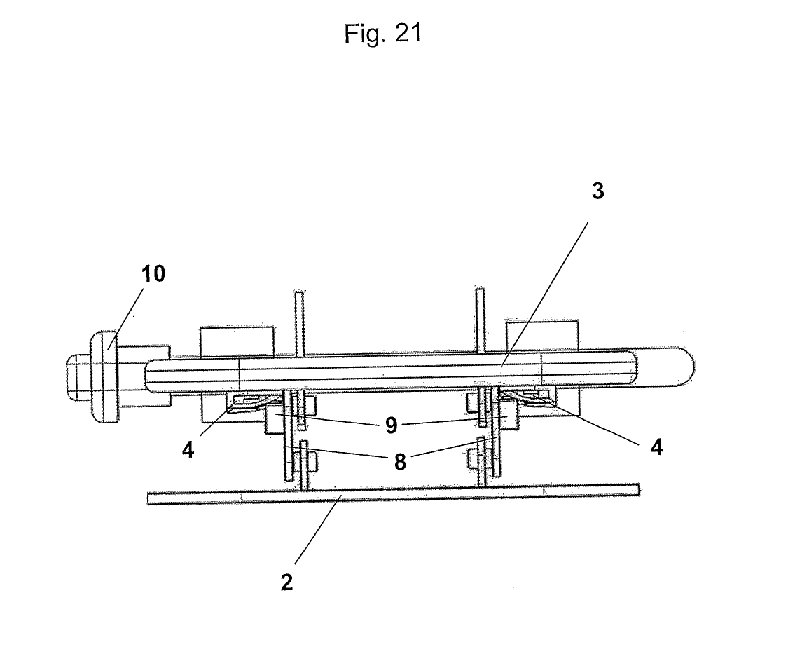

FIG. 21 shows a top view of the anti-whiplash system in an activated state.

FIG. 22 shows a perspective view of a stowable head restraint in an operative position provided with an anti-whiplash system in an initial state.

FIG. 23 shows a perspective view of a stowable head restraint stowed away in an inoperable position provided with an anti-whiplash system in an initial state.

The active head restraint 1 shown in FIGS. 1 to 10 comprises a release mechanism for reducing the gap between an occupant's head and the head restraint 1 in case of an accident. The head-engaging member 2 is mounted on carrier bars 11 that are connected to a preassembled head restraint mounting unit 12 which is mounted in the backrest of the vehicle seat (not shown). The anti-whiplash system comprises essentially a movable part 5 and a stationary part 3. The stationary part 3 is mounted on the backrest of a vehicle seat (not shown). The movable part 5 is connected pivotably about a transversal axis A to the stationary part 3. Upon activation of the anti-whiplash system the movable part 5 pivots forward and moves the attached head-engaging member 2 essentially towards an occupant's head (not shown) such that the gap between the head restraint and an occupant's head is reduced. At one or both lateral sides of the preassembled head restraint mounting unit 12 there is a wedging body 4 connected rotatably about a vertical axis to the stationary part 3 of the anti-whiplash system. By means of a spring 6 the wedging body 4 is preloaded and abuts with its small width portion against the movable part 5 adjacent to the clearance between the movable part 5 and the stationary part 3 that opens up upon a forward pivot movement of the movable part 5 about the cross-vehicle axis A during an activation process. FIGS. 1 and 4 show the anti-whiplash system in an activated state.

Furthermore, the head restraint 1 can be stowed away by a pivot movement of the head-engaging member 2 about a transversal axis B parallel to axis A. The head-engaging member 2 is connected pivotably about the transversal axis B to the movable part 5 via carrier bars 11. FIGS. 2 and 5 show the head restraint stowed away in an inoperable stowage position after a pivot movement of the head-engaging member 2 about the transversal axis B.

FIGS. 9 and 10 show the active head restraint 1 in an activated state where the gap between an occupant's head and the head restraint 1 is reduced by a forward pivot movement of the movable part 5 about the cross-vehicle axis A. Upon such a forward pivot movement a clearance in form of an angle 7 opens up. The clearance may be filled gradually by the rotatable and preloaded wedging body 4 that rotates about a vertical axis into the clearance and prevents the movable part 5 of the head restraint 1 from moving back.

A second embodiment of the invention is shown in FIGS. 11 to 21. In this embodiment the head-engaging member 2 is connected to at least one rotatable cam 8 such that the gap between an occupant's head and the head-engaging member 2 is reduced upon a concerted rotation of the cam 8 about a transversal axis. The preloaded movable wedging body 4 is urged to move into a clearance that opens up upon rotation of the cam 8 in order to prevent the cams 8 from rotating back. The cam 8 comprises an extension 9 provided on the surface of the cam 8 such that the extension 9 follows a circular path away from the stationary part 3 when the cam 8 rotates about a transversal axis A upon actuation of the anti-whiplash system. The clearance may open up between the extension 9 on the cam 8 and the stationary part 3 of the release mechanism. As can be seen in FIGS. 6 to 12 the wedging body 4 is connected rotatably about an longitudinal axis to the stationary part 3. By means of a spring the wedging body 4 is preloaded and abuts with its small width portion against the extension 9 of the cam 8. The clearance between the extension 9 of the cam 8 and the stationary part 3 opens up upon a rotation of the cam 8 about a transversal axis A during an activation process. As soon as the clearance is large enough to engage the small width portion of the wedging body 4 the wedging body 4 rotates about a longitudinal axis such that it fills the clearance and prevents the cam 8 from moving back. When the cam 8 has reached the activated position as shown in FIGS. 7, 9, 11 and 12 the clearance is maximally opened up and the wedging body 4 has reached its final blocking position.

In FIGS. 13 and 16 the vehicle seat's head restraint according to the second embodiment of the invention is shown in a stowage position. The stationary part 3 is connected rotatably about a folding axis B with the carrier bars 11 for folding of the head restraint 1 to an inoperable stowage position.

A third embodiment of the invention is shown in FIGS. 22 and 23. This embodiment exhibits features of the first and the second above-mentioned embodiments. The head-engaging member 2 is connected to the stationary part 3 which is mounted rotatably about a folding axis B on a preassembled head restraint mounting unit 12. The preassembled head restraint mounting unit 12 itself is mounted the backrest of the vehicle seat (not shown). The head-engaging member 2 is connected to rotatable cams 8 such that the gap between an occupant's head and the head-engaging member 2 is reduced upon a concerted rotation of the cams 8 about an transversal axis. The head-engaging member 2 and the cams 8 establish the movable part 5 of the anti-whiplash system. The head restraint 1 can be stowed away by a pivot movement of the stationary part 3 about a transversal axis B parallel to axis A.

1. A vehicle seat having a backrest comprising:
a head restraint (1) adapted to be mounted on the backrest, wherein the head restraint (1) comprises a mechanism for folding the head restraint between at least one fixed operative position and at least one stowage position,
an anti-whiplash system including a release mechanism associated with the head restraint (1), with the release mechanism reducing a gap between an occupant's head and the head restraint (1) in an accident when the head restraint (1) is in the operative position,
the release mechanism including a movable part (5) and a stationary part (3), wherein a clearance between the movable part (5) and the stationary part (3) opens up when the release mechanism is released,
the release mechanism further including a wedging body (4) having a small width portion and a large width portion and an intermediate increasing width portion, and
the small width portion of the wedging body (4) pointing toward the clearance between the movable part (5) and the stationary part (3) with the wedging body (4) movable and preloaded to move into the clearance as the clearance opens up such that the wedging body (4) abuts against the movable part (5) and against the stationary part (3) to prevent the movable part (5) of the head restraint (1) from moving back to an initial position.

2. A vehicle seat according to claim 1, further including a preassembled head restraint mounting unit (12) adapted to be mounted in the backrest with the preassembled head restraint mounting unit (12) comprising the mechanism for folding the head restraint (1) and the anti-whiplash system.

3. A vehicle seat according to claim 1, wherein the mechanism for folding the head restraint (1) and the anti-whiplash system are each placed in the head restraint (1).

4. A vehicle seat according to claim 1, further including a preassembled head restraint mounting unit (12) adapted to be mounted in the backrest with the preassembled head restraint mounting unit (12) comprising the mechanism for folding the head restraint (1), while the anti-whiplash system is placed in the head restraint (1).

5. (canceled)

6. A vehicle seat according to claim 1, wherein the wedging body (4) is preloaded by a spring (6).

7. A vehicle seat according to claim 1, wherein the wedging body (4) is an essentially wedge-shaped body.

8. A vehicle seat according to claim 1, wherein the wedging body (4) is rotatable and comprises a helically shaped surface portion winding up from the small width portion via the intermediate increasing width portion to the large width portion.

9. A vehicle seat according to claim 8, wherein the wedging body (4) is urged to gradually rotate into the clearance when the release mechanism is released to prevent the movable part (5) of the head restraint (1) from moving back to the initial position.

10. A vehicle seat according to claim 1, wherein the release mechanism pivots the movable part (5) of the head restraint (1) forward with respect to the backrest such that an angular-shaped clearance (7) between the movable part (5) and the stationary part (3) opens up near a pivot axis (A) when the release mechanism is deployed and the movable wedging body (4) is urged to move into the angular-shaped clearance (7).

11. A vehicle seat according to claim 10, wherein the head restraint (1) is connected rotatably about a folding axis (B) parallel to the pivot axis (A) for folding the head restraint (1) to the stowage position.

12. A vehicle seat according to claim 1, wherein the movable part (5) comprises a head engaging member (2) and at least one rotatable cam (8) attached to the head engaging member (2), wherein the rotatable cam (8) is rotatably attached to the stationary part (3) such that the gap between the head engaging member (2) and the stationary part (3) increases upon rotation of the cam (8), wherein the cam (8) comprises an extension (9) with the extension (9) following a circular path away from the stationary part (3) when the cam (8) rotates such that the clearance opens up between the extension (9) of the cam (8) and the stationary part (3), and wherein the movable wedging body (4) is preloaded to move into the clearance as the clearance opens up such that the wedging body (4) abuts against the extension (9) of the cam (8) and against the stationary part (3) to prevent the movable part (5) of the head restraint from moving back to the initial position.

13. A vehicle seat according to claim 12, wherein the stationary part (3) is rotatably coupled about a folding axis (B) to carrier bars (11) for folding of the head restraint (1) to the stowage position.

14. A vehicle seat according to claim 12, wherein the stationary part (3) is rotatably about a folding axis (B) to the backrest for folding of the head restraint (1) to the stowage position.

15. A vehicle seat according to claim 1, wherein the release mechanism comprises a returning mechanism (10) for returning the head restraint to an initial position after the release mechanism has been released, wherein the returning mechanism comprises means for returning the movable wedging body back to an initial preloaded position.
